(19) United States
(12) Patent Application Publication
(10) Pub. No.: US 2010/0237059 A1
(43) Pub. Date: Sep. 23, 2010

(54) RESISTIVE HEATING ELEMENT FOR ELECTRICAL HEATING

(75) Inventors: Donald E. Porterfield, Lascassas, TN (US); Jerry L. Hensley, Lebanon, TN (US); Donald G. Leeman, Murfreesboro, TN (US); Charles T. Whitfield, Murfreesboro, TN (US)

Correspondence Address: HARNESS, DICKEY & PIERCE, P.L.C., P.O. BOX 828, BLOOMFIELD HILLS, MI, 48303, US

(73) Assignee: Emerson Electric Co., St. Louis, MO (US)

(21) Appl. No.: 12/726,688

(22) Filed: Mar. 18, 2010

Related U.S. Application Data
(60) Provisional application No. 61/161,701, filed on Mar. 19, 2009.

(51) Int. Cl. H05B 3/02; H01C 17/00

(52) U.S. Cl. 219/482; 29/611

(57) ABSTRACT

A resistive heating element for a resistance heater includes a first heating section and a second heating section. The first and second heating sections are configured to jointly generate a power output that is equal to that generated by a single reference resistive element under a same applied voltage. The single reference resistive element has a reference length, a reference mass, and a reference surface area. The first and second heating sections are configured to transfer an amount of heat at least equal to that transferred by the single reference resistive element. A total mass of the first heating section and the second heating section is less than a reference mass of the single reference resistive wire.

### CROSS-REFERENCE TO RELATED APPLICATIONS

This application claims the benefit of U.S. Provisional Application No. 61/161,701, filed on Mar. 19, 2009. The entire disclosure of the above application is incorporated herein by reference.

The present disclosure relates to electrical heaters, fluid moving applications, and appliances. In particular, the present disclosure relates to open coil heaters that include resistive heating elements with improved structures to reduce material costs.

### BACKGROUND

The statements in this section merely provide background information related to the present disclosure and may not constitute prior art.

An open coil heater generally includes a resistive heating element to generate heat. The resistive heating element is generally in the form of a coiled wire and generates heat as electrical current passes therethrough. The resistive heating element is in direct contact with a surrounding fluid, such as air or water, for example. Heat exchange between the resistive heating element and the surrounding fluid is efficient. Therefore, a quick response time can be achieved.

The length, material, and diameter (e.g., the wire gauge) of the coiled wire of the resistive heating element need to be properly selected to generate a desired heat output. The selection of an appropriate wire type, wire gauge and length requires experience. While standard coiled resistive wires may be used, the coiled resistive wires are generally custom-made for a specific application.

### SUMMARY

A resistive heating element for a resistance heater is provided. In one form, a resistive heating element for a resistance heater includes a first heating section and a second heating section. The first and second heating sections are configured to jointly generate a power output that is equal to that generated by a single reference resistive element under a same applied voltage. The single reference resistive element has a reference length, a reference mass, and a reference surface area. The first and second heating sections are configured to transfer an amount of heat equal to that transferred by the single reference resistive element. A total mass of the first heating section and the second heating section is less than a reference mass of the single reference resistive element.

In another form, a resistive heating element for a resistance heater includes a plurality of heating sections connected in parallel. The plurality of heating sections are configured to generate a total power output that is equal to a reference power output generated by a single reference resistive element. A resultant resistance of the plurality of heating sections is equal to a reference resistance of the single reference resistive element. The plurality of heating sections each have a cross-sectional area less than a reference cross-sectional area of the single reference resistive element. A total length of the plurality of heating sections is greater than a reference length of the single reference resistive wire. A total surface area of the plurality of the heating sections is at least equal to a reference surface area of the reference single resistive heating element to provide a heat transfer efficiency at least equal to that of the single reference resistive element. A total mass of the plurality of the heating sections is less than a reference mass of the single resistive heating element.

In still another form, a method of manufacturing an electrical heater includes: determining a desired power output; determining a single reference resistive wire that generates the desired power output, the single reference resistive wire defining a reference resistance, a reference length, a reference diameter, and a reference surface area; and selecting a plurality of heating sections that has a resultant resistance equal to a reference resistance of the single reference resistive wire. A total surface area of the plurality of heating sections is equal to the reference surface area of the single resistive wire. At least one of the plurality of heating sections has a diameter less than a reference diameter of the single reference resistive wire.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIGS. 1A and 1B are a schematic plan view and a schematic side view, respectively, of a prior art electrical heater;

FIG. 2 is a schematic electric circuit diagram of the prior art electrical heater of FIG. 1;

FIG. 3 is a schematic plan view of an electrical heater according to a first embodiment of the present disclosure;

FIG. 4 is a schematic electric circuit diagram of the electrical heater of FIG. 3;

FIG. 5 is a schematic plan view of an electrical heater according to a second embodiment of the present disclosure; and

FIG. 6 is a schematic electric circuit diagram of the electrical heater of FIG. 5.

### DETAILED DESCRIPTION

The following description is merely exemplary in nature and is not intended to limit the present disclosure, application, or uses. It should be understood that throughout the drawings, corresponding reference numerals indicate like or corresponding parts and features.

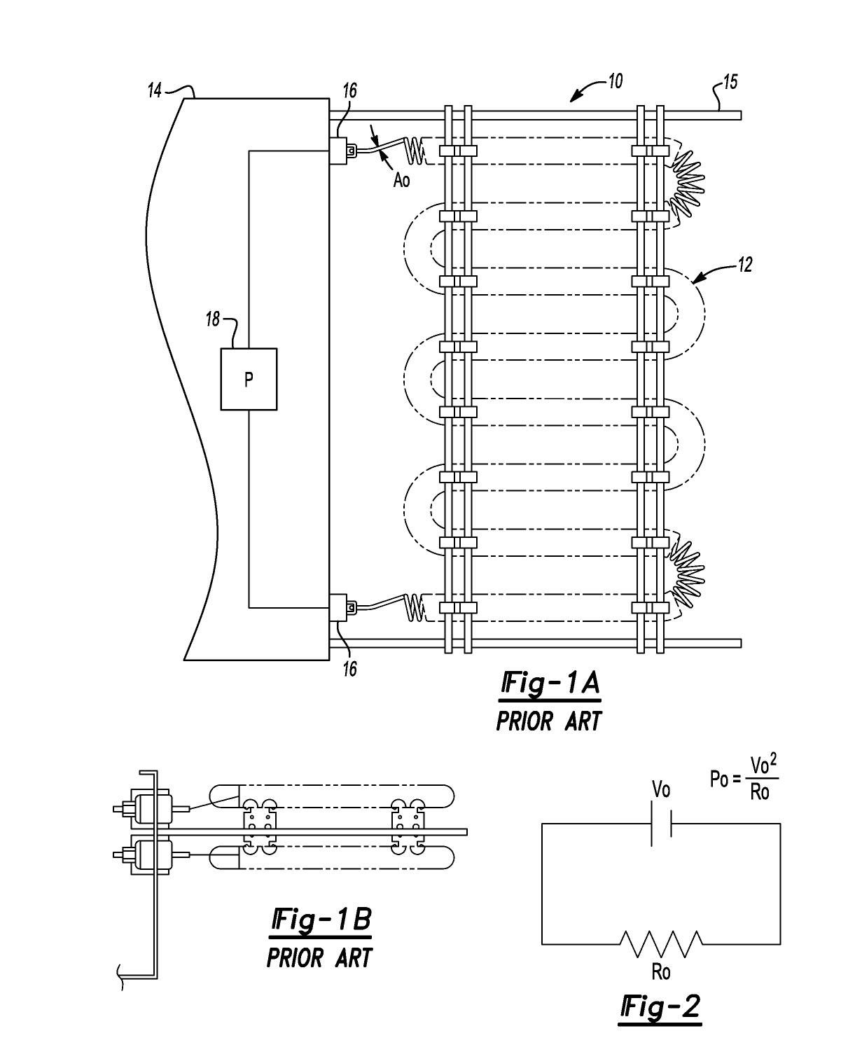

Referring to FIG. 1, a prior art electrical heater 10 includes a resistive heating element 12 and a housing 14. A support 15 extends outwardly from the housing 14 and secures the resistive heating element 12 to the housing 14. A pair of terminals 16 connects the resistive heating element 12 to a power source 18, which supplies electric current to the resistive heating element 12. Resistive heat is generated by the ohmic or resistive losses that occur when electrical current flows through the resistive heating element 12. The heat generated in the resistive heating element 12 is then transferred to the surrounding environment.

The resistive heating element 12 is a single, coiled resistive wire having a cross-sectional area A₀ and a diameter D₀ and extending an (uncoiled) length L₀ between the terminals 16. The diameter D₀ may be indicated by a gauge number under American Wire Gauge (AWG) System. In the American Wire Gauge System, a (AWG) gauge number represents a standard diameter of a round, solid electrically conducting wire. The larger the gauge number, the smaller the wire diameter. The surface area of the resistive heating element 12 exposed to the surrounding environment is approximately π-D₀L₀. The cross-sectional area A₀ of the resistive wire is approximately π-D₀²/4.

Referring to FIG. 2, the electrical heater 10 generates a power output P₀, which can be expressed by the following equation:

$${P}_{0} = \frac{{V}_{0}^{2}}{{R}_{0}} \qquad ( eq . 1 )$$

wherein V₀ is a voltage of the power source 18 and R₀ is an electrical resistance of the resistive heating element 12.

The heat generated by the resistive heating element 12 through ohmic losses is equal to the power output P₀. The actual heat transfer from the resistive heating element 12 to the surrounding environment, however, is generally less than the power output P₀ and depends on efficiency of heat transfer.

By way of example, it is known to produce a 5000 W heater by employing a single 5000 W heating element, comprising a coiled 16 gauge wire having a resistance of about 10.5 ohms and weighing about 0.290 lb., in a single circuit in the heater. To produce a 10 kW heater, then two (2) 5000 W heating elements are employed in two circuits in the heater (see, e.g., FIG. 1B). To produce a 15 kW heater, then three (3) 5000 W heating elements are employed in three circuits in the heater; and so on.

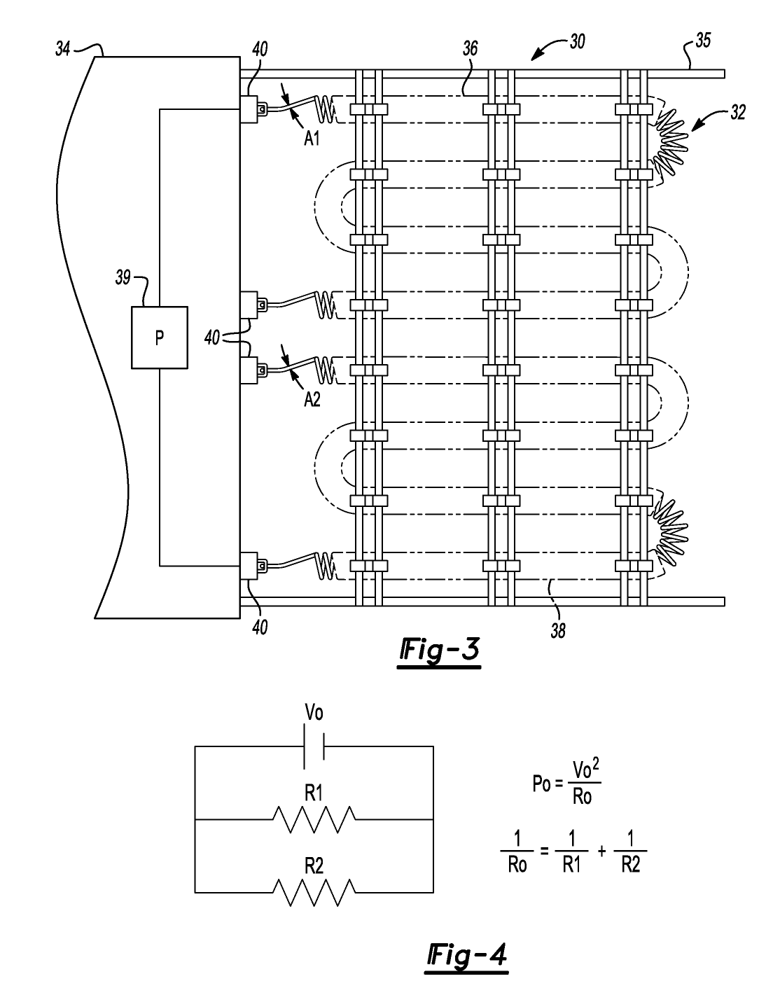

Referring to FIG. 3, an exemplary 5000 W electrical heater 30 for an appliance according to a first embodiment of the present disclosure is shown. The electrical heater 30 is configured to generate the same amount of power output P₀ and allows the same amount of heat transfer to the surrounding environment under the same applied voltage V₀, as in the prior art electric heater 10. The electrical heater 30 of the present disclosure has a structure resulting in material reduction and corresponding savings in material costs.

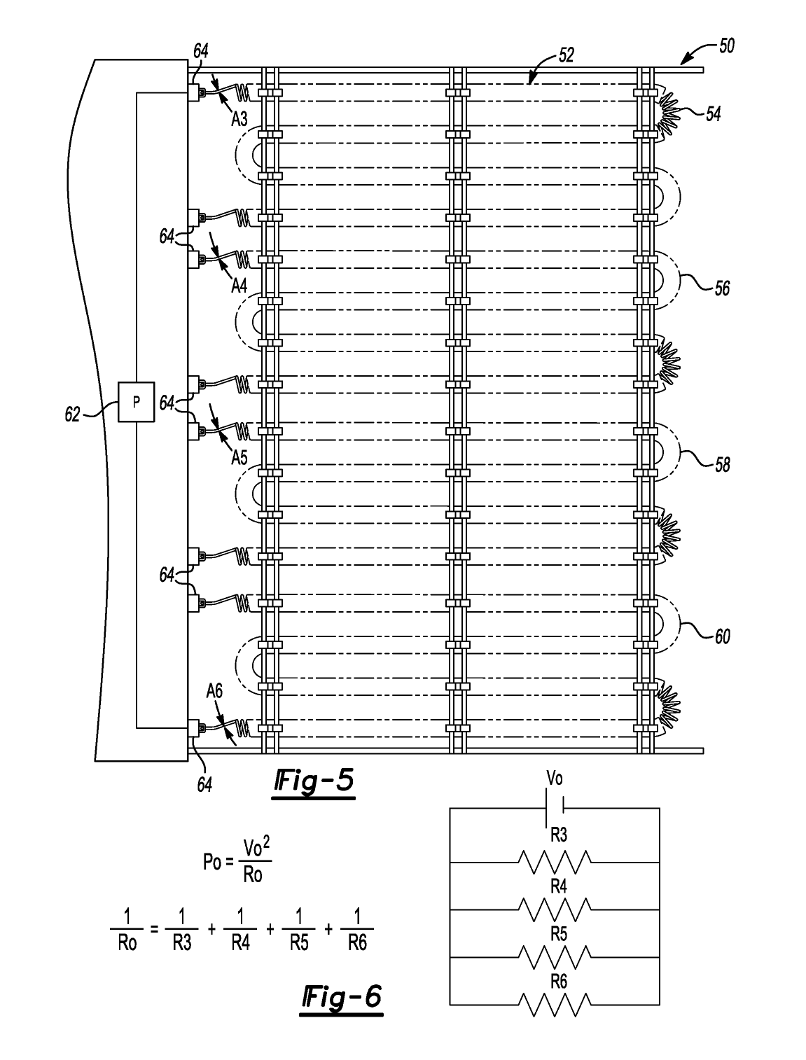

More specifically, the electrical heater 30 is an open coil heater and is shown to include a resistive heating element 32 comprising a coiled resistance wire and a housing 34. A support 35 extends outwardly from the housing 34 and secures the resistive heating element 32 to the housing 34. The resistive heating element 32 is exposed to the surrounding environment and in direct contact with the surrounding medium, such as air. The coils of the resistive heating element 32 (though represented in FIGS. 3 and 5 to be generally of a uniform circular cross-section and extending along a serpentine path) may be configured in any of a variety of uniform or varying geometries (both in cross-section and in plan view), including circular, oval, rectangular, D-shaped, and polygonal, for example. The electrical heater 30 may be used in HVAC applications or household appliances, including but not limited to, clothes dryers, heated air curtains, air chambers, incubators, environmental chambers, and duct heaters, to name a few.

The resistive heating element 32 may include coiled resistive wires made from a metal or alloy, such as, but not limited to, a Nickel-Chromium alloy, an Iron-Chromium-Aluminum alloy, and a Nickel-Chromium-Iron alloy. Any suitable alloy may be utilized without departing from the scope of the present disclosure. Alternatively, the resistive heating element 32 may comprise a resistive ribbon element(s) instead of a wire(s), as described below. The resistive heating element 32 includes a first heating section 36 and a second heating section 38. Dimensions of the resistive wire (or other resistive element) for the first heating section 36 and the second heating section 38 are expressed relative to the dimensions for the resistive element of the single resistive heating element 12 of FIG. 1A. Therefore, the single resistive heating element 12 of FIG. 1A is referred to as a “reference resistive element,” and its wire diameter D₀ (in the case of a round wire), (uncoiled) length L₀, surface area A_{S0}, electrical resistance R₀, cross-sectional area A₀ are referred to as “reference diameter,” “reference length,” “reference surface area,” “reference resistance”, and “reference cross-sectional area” respectively.

The first heating section 36 and the second heating section 38 are configured to have a resultant resistance equal to the reference resistance R₀. Therefore, the first and second heating sections 36 and 38 generate a total power output equal to the reference power output P₀. The heat generated by the resistive heating element 32 through ohmic or resistive loss is equal to the heat generated by the reference resistive wire 12 of FIG. 1A.

The first and second heating sections 36 and 38 are connected to a power source 39 through a plurality of terminals 40. The terminals 40 include any suitable electrical conductor for conducting electrical current from the power source 39 to the first and second heating sections 36 and 38. The terminals 40 can be manufactured from a metal (such as steel or copper), or from a bimetallic construction (such as a copper core steel pin).

The first and second heating sections 36 and 38 extend between their respective terminals 40 to define a serpentine shape. The first heating section 36 has a first length L₁, a first surface area A_{S1}, and a first cross-sectional area A₁. When the first heating section 36 is a round wire, the first surface area A_{S1} is approximately equal to πD₁L₁ and the first cross-sectional area a₁ is approximately equal to πD₁²/4, wherein D₁ is the diameter of the round wire. When the first heating section 36 is in the form of a ribbon element, the first surface area A_{S1} is approximately equal to 2(b₁+t₁)L₁ and the first cross-sectional area a₁ is approximately equal to b₁·t₁, wherein b₁ is the width of the ribbon element, t₁ is the thickness of the ribbon element.

Similarly, the second heating section 38 has a second length L₂, a second surface area A_{S2}, and a second cross-sectional area A₂. When the second heating section 38 is a round wire, the second surface area A_{S2} is approximately equal to πD₂L₂, and the second cross-sectional area A₂ is approximately equal to πD₂²/4, wherein D₂ is the diameter of the round wire. When the second heating section 38 is in the form of a ribbon element, the second surface area A_{S2} is approximately equal to 2(b₂+t₂)L₂ and the second cross-sectional area A₂ is approximately equal to b₂·t₂, wherein b₂ is the width of the ribbon element and t₂ is the thickness of the second ribbon element.

The first and second heating sections 36 and 38 are configured to have a total surface area (A_{S1}+A_{S2}) approximately equal to the reference surface area A_{S0}. At least one of first cross-sectional area A₁ and the second cross-sectional area A₂ is less than the reference cross-sectional area A₀. When the reference resistive heating element and the first and the second heating sections 36 and 38 are in the form of round wires, at least one of the first diameter D₁ and the second diameter D₂ is less than the reference diameter D₀. Therefore, a total length (L₁+L₂) is greater than the reference length L₀ to maintain the same surface area. By making the total length (L₁+L₂) larger than the reference length L₀ and by making the first cross-sectional area A₁ and/or the second cross-sectional area A₂ less than the reference cross-sectional area A₀, a total mass (or weight) of the first and second heating sections 36 and 38 is less than a reference mass (or weight) of the single reference resistive element 12.

A resistive heating element of an open coil heater may be arranged in a number of ways to generate the same power output (i.e., P₀). The actual heat transfer from the resistive heating element to the surrounding environment, however, may not be the same, depending on efficiency of heat transfer. In an open coil heater, the resistive heating element is exposed to the surrounding environment, such as open air, and heat is transferred to the surrounding environment mostly through convection. Heat transferred from a relatively hot source (for example, the resistive heating element) to the surrounding environment is proportional to the surface area of the hot source. The efficiency of heat transfer from the resistive heating element 32 and consequently the actual heat output to the environment remain the same when the total surface area is not changed. Therefore, by maintaining the same power output, the resistive heating element 32 of this embodiment generates the same theoretical heat output due to ohmic loss. By maintaining the same surface area, the resistive heating element 32 achieves the same efficiency of heat transfer and outputs the same amount of heat to the environment, taking into account the heat transfer efficiency.

By reducing the cross-sectional area of the first and/or second resistive heating section 36, 38, a total mass of material needed for constructing the first and second heating sections 36 and 38 can be reduced when a same material is used. Mass of a resistive wire is proportional to the cross-sectional area (and square of radius in the case or a round wire) and is directly proportional to the length. While the total length is increased, the reduced cross-sectional area of at least one of the first and second heating sections 36 and 38 results in a mass/weight reduction. Therefore, less material is needed to form the resistive heating element 32, thereby reducing the material use and corresponding costs.

Referring to FIG. 4, as previously described, the first and second heating sections 36 and 38 are configured to provide a resultant resistance equal to the reference resistance R₀. Electrical resistance of a conductor is directly proportional to the length and inversely proportional to the cross-sectional area as follows:

$$R = ρ \frac{L}{A} \qquad ( eq . 2 )$$

wherein R is the electrical resistance of a conductor, ρ is resistivity of a conductor, L is the length of the conductor, and A is the cross-sectional area of the conductor.

According to Joule's law, resistance R may also be represented as follows:

$$R = \frac{{V}^{2}}{P} \qquad ( eq . 3 )$$

wherein V is the potential (in volts) and P is the power or energy rate of transfer across the resistor. Substituting for R of eq. 3 into eq. 2, then

$$\frac{{V}^{2}}{P} = ρ \frac{L}{A} \qquad ( eq . 3 )$$

Therefore, when the first and second heating sections 36 and 38 are longer and thinner than the single reference resistive heating element 12, the resistance R₁ and R₂ of the first and second heating sections 36 and 38 become greater than the reference resistance R₀. The first and second heating sections 36 and 38 may be connected in parallel to have a resultant resistance equal to the reference resistance R₀.

To simplify the determination of dimensions of the resistive heating element 32, the first heating section 36 and the second heating section 38 may be made of the same material and be configured to have the same dimensions, i.e., L₁=L₂, A₁=A₂ (or D₁=D₂). The first and second heating sections 36 and 38 may each have an electric resistance of 2R₀ and are connected in parallel. The resultant resistance, therefore, is equal to the reference resistance R₀ and the power output P₀ remains the same.

The following example is illustrative. First, consider a single, 5000 W resistive heating element operating at 240 Volts (V). The heating element is made from 16 AWG Kanthal® NIKROTHAL® 60 wire material. Kanthal® NIKROTHAL® 60 is a known nickel-chromium-iron alloy suitable for heating elements for household appliances and the like that is available from Kanthal A B, Hallstahammar, Sweden. The 16 AWG wire has a diameter (D)=0.0508 in. The resistivity (ρ) of NIKROTHAL® 60=1.11Ω·mm²·m⁻¹[4.37×10⁻⁵Ω·in²·in⁻¹] and it has a temperature factor of resistivity (Cₜ) @600-700° C. of about 1.09. In a 16 AWG wire, the NIKROTHAL® 60 weighs 0.0072 lb./ft.

From the foregoing, it can be calculated that a 16 gauge NIKROTHAL® 60 heating wire of approximately 490.18 in. (40.8 ft.) in length and weighing approximately 0.294 lb. is needed to construct the 5000 Watt resistance heater. Such a heating element would produce about 63.9 Watts/in.² of the heating element's surface, consistent with HVAC heater design guidelines which generally suggest about 65 Watts/in.²

Now consider the following. In the electrical heater 30 of FIG. 3, the first and second heating sections 36 and 38 may each include a 20 gauge, 2500 Watt heating element, also made from NIKROTHAL® 60 nickel-chromium-iron alloy. Accordingly, it can be calculated that each of the two (2) 20 gauge heating elements includes a length of wire of about 389 in. (32.4 ft.). The total power output, though, is 5000 W. The total surface area remains, for all practical purposes, the same, producing about 63.9 Watts/in.² of the heating element's surface. Therefore, the heat transfer efficiency to the environment remains the same. The total amount of nickel-chromium-iron alloy needed for constructing the two 20 gauge 2500 Watt coils, however, is only 0.185 lb., because the smaller diameter (D=0.0320 in.) 20 gauge NIKROTHAL® 60 wire weighs 0.00286 lb./ft. The material savings is 0.109 lb., a 37% reduction in material.

As previously described, additional circuits may be added to produce heaters of 10 kW, 15 kW, and so on.

Referring to FIG. 5, an electrical heater 50 according to a second embodiment of the present disclosure includes a resistive heating element 52. The resistive heating element 52 includes a first heating portion 54, a second heating portion 56, a third heating portion 58, and a fourth heating portion 60 that are connected in parallel. The first, second, third and fourth heating portions 54, 56, 58 and 60 are connected to a power source 62 through a plurality of terminals 64.

The cross-sectional areas A₃, A₄, A₅, and A₆ (or diameters D₃, D₄, D₅, D₆ in case of round wires) of the first, second, third and fourth heating portion 54, 56, 58 and 60 are smaller than cross-sectional areas A₁ and A₂ (or diameters D₁ and D₂) of the first and second heating sections 36 and 38. The total length (L₃+L₄+L₅+L₆) of the first, second, third and fourth heating portions 54, 56, 58 and 60 is greater than the total length of the first and second heating sections 36 and 38. The heating portion 54, 56, 58 and 60 are configured to be longer and thinner than the heating sections 36 and 38 of FIG. 3 to maintain the same surface area, and consequently the same heat transfer efficiency.

Referring to FIG. 6, the four heating portions 54, 56, 58 and 60 may be connected in parallel to have a resultant resistance of R₀ to generate a total power output equal to the reference power output P₀. The total mass of the heating portions 54, 56, 58 and 60 is further reduced compared with that in FIG. 3, when the same material is used to form the four heating portions 54, 56, 58, and the reference resistive wire.

The concept of weight reduction is not limited to a heating element having a circular or rectangular cross section. The concept of weight reduction can be applied to any shape including, but not limited to, circular, oval, rectangular, square, and triangular, for example, without departing from the scope of the present disclosure. In addition, the concept of weight reduction can be applied to resistive heating elements wherein the reference resistive heating element and the desired resistive heating element have different shapes. For example, a reference resistive element may be a coil wire, whereas the desired resistive heating element that has a reduced mass may be a ribbon element.

More specifically, to build a 10 kW heater, two 16 gauge nickel-chromium coil wires connected in parallel may be used, as previously described in connection with FIGS. 1A and 1B. The resistance for each of the two 16 gauge nickel-chromium coil wires is 10.5 ohms. A ribbon element made of nickel-chromium may be used to replace the two coiled 16 gauge wires. To maintain the same surface area and the same resistance, the ribbon element is 3/16 inch wide and 0.004 inch thick. To make the ribbon element into dual ribbon strands, the ribbon element may be slit in half along the longitudinal direction of the ribbon element. Therefore, the dual ribbon strands each have a resistance twice as large as that of the single ribbon element. By connecting the two ribbon strands in parallel, the resultant resistance of the dual ribbon strands remains equal to the resistance of the single ribbon element (which is the same as the two 16 gauge nickel-chromium coil wires). The dual ribbon strands generate the same power under the same applied voltage as that of the two 16 gauge nickel-chromium coils, but the mass of the materials for constructing the dual ribbon strands is reduced.

It is understood and appreciated that while the resistive heating element 32 or 52 has been described to include two or four heating sections, the resistive heating element can include any number of heating sections without departing from the scope of the present disclosure. Moreover, the plurality of heating sections may be connected in a number of ways to achieve the desired, reference power output (i.e., same theoretical heat output by ohmic loss) and to maintain the same surface area (i.e., same efficiency of heat transfer to the surrounding environment). For example, some of the heating sections may be connected in series and some of the heating sections may be connected in parallel.

It is also understood and appreciated that, in some situations, the total surface area of the plurality of heating sections may become different from the reference surface area of a reference resistive element if the power output, the applied voltage, the resultant resistance remain the same. For example, a first material for constructing the reference element may be different from a second material for constructing the desired resistive element having multiple heating sections. In this situation, the dimensions of the multiple heating sections may be properly selected so that the multiple heating sections have the same resultant resistance to generate the same power output under the same applied voltage but with a reduced mass of the second material.

The disclosure of the present disclosure can be applied to an electrical heater that heats an adjacent object or fluid by conduction, radiation, or convection. The amount of heat transfer from the resistive heating element to an adjacent object or fluid by conduction, radiation, or convection is proportional to the exposed surface area. Therefore, the concept of material reduction by reducing the diameter of the resistive heating element while maintaining the same exposed surface area is equally applicable to a resistive heating element that transfers heat by conduction, radiation, or convection.

This description is merely exemplary in nature and, thus, variations that do not depart from the gist of the disclosure are intended to be included within the scope of the disclosure. Further areas of applicability of the present invention will become apparent from the detailed description provided hereinafter. It should be understood that the description and specific examples, while indicating the preferred embodiments of the invention, are intended for purposes of illustration only and are not intended to limit the scope of this disclosure.

What is claimed is:

1. A resistive heating element for a resistance heater comprising:
a first heating section; and
a second heating section,
wherein the first and second heating sections are configured to jointly generate a power output that is equal to that generated by a reference resistive heating element having a single heating section under a same applied voltage, the single reference resistive element having a reference length, a reference mass, and a reference surface area, and a reference cross-sectional area,
wherein the first and second heating sections are configured to have a resultant resistance equal to a resistance of the single resistive element, and
wherein a total mass of the first heating section and the second heating section is less than the reference mass of the single reference resistive element.

2. The resistive heating element of claim 1, wherein at least one of the first heating section and the second heating section has a cross-sectional area smaller than the reference cross-sectional area.

3. The resistive heating element of claim 2, wherein a total surface area of the first heating section and the second heating is equal to the reference surface area.

4. The resistive heating element of claim 1, wherein a total length of the first and second heating sections is greater than the reference length of the reference resistive element.

5. The resistive heating element of claim 1, wherein the first heating section and the second heating section are connected in parallel.

6. The resistive heating element of claim 1, wherein the first heating section and the second heating section each include a coiled wire.

7. The resistive heating element of claim 6, wherein the first heating section and the second heating section each have a diameter smaller than a reference diameter of the reference resistive element.

8. The resistive heating element of claim 1, wherein the first and second heating sections have a heat transfer efficiency equal to that of the reference resistive element.

9. The resistive heating element of claim 1, wherein the first and second heating sections are made of a flexible material.

10. The resistive heating element of claim 1, wherein the first and second heating sections each comprise an electrically conductive wire having a cross-section selected from a group consisting of circle, oval, rectangle, square, and triangle.

11. The resistive heating element of claim 1, wherein at least one of the first and second heating sections comprises an electrically conductive ribbon element.

12. A resistive heating element for a resistance heater of the type that generates a predetermined power output when a single resistive element made of a predetermined material and having a predetermined surface area and a predetermined cross-sectional area is used, the improvement comprising:
a plurality of resistive heating sections made of the predetermined material and operable in combination to produce a total power output at least equal to the predetermined power output,
wherein a total surface area of the plurality of resistive heating sections is at least equal to the predetermined surface area,
wherein at least one of the plurality of resistive heating sections has a cross-sectional area smaller than the predetermined cross-sectional area and cross-sectional areas of the plurality of resistive heating sections are not greater than the cross-sectional area, and
wherein a total mass of the plurality of resistive heating elements is substantially less than that of the single resistive element.

13. A resistive heating element for a resistance heater, comprising:
a plurality of heating sections connected in parallel,
wherein the plurality of heating sections generate a total power output that is equal to a reference power output generated by a single reference resistive wire,
wherein a resultant resistance of the plurality of heating sections is equal to a reference resistance of the single reference resistive wire,
wherein the plurality of heating sections each have a diameter less than a reference diameter of the single reference resistive wire,
wherein a total length of the plurality of heating sections is greater than a reference length of the single reference resistive wire,
wherein a total surface area of the plurality of the heating sections is equal to a reference surface area of the reference single resistive heating element to provide a heat transfer efficiency at least equal to that of the single reference resistive wire, and
where a total mass of the plurality of the heating sections is less than a reference mass of the single reference resistive heating element.

14. A method of manufacturing an electrical heater, comprising:
determining a desired power output;
determining a single reference resistive element that generates the desired power output, the single reference resistive element having a reference resistance, a reference length, a reference cross-sectional area, a reference surface area, and a reference mass;
selecting a plurality of resistive elements that has a resultant resistance equal to the reference resistance of the single reference resistive element, wherein a total mass of the plurality of resistive elements is less than the reference mass of the single reference resistive element; and
connecting the plurality of resistive elements in parallel.

15. The method of claim 14, wherein a total surface area of the plurality of resistive elements is equal to the reference surface area of the single resistive element.

16. The method of claim 15, wherein at least one of the plurality of resistive elements has a cross-sectional area less than the reference cross-sectional area of the single reference resistive element.

17. The method of claim 14, wherein the plurality of resistive elements each have a diameter less than a reference diameter of the single reference resistive element.

18. The method of claim 14, wherein a total length of the plurality of resistive elements is greater than the reference length of the single reference resistive element.

19. The method of claim 14, wherein the plurality of resistive elements each comprise a single coiled wire.

20. In a resistance heater of the type that generates a predetermined power output when a resistive heating element made from a predetermined material has a predetermined cross-sectional area and a predetermined surface area, the improvement comprising:
the resistive heating element comprising a plurality of sections made from the predetermined material and operable in combination to produce a total power output at least equal to the predetermined power output,
wherein a total surface area of the plurality of sections is at least equal to the predetermined surface area,
wherein at least one of the plurality of sections has a cross-sectional area smaller than the predetermined cross-sectional area, and the other of the plurality of sections have cross-sectional areas not greater than the predetermined cross-sectional area, and
wherein a total mass of the plurality of sections is less than that of the resistive heating element having the predetermined cross-sectional area.

21. In a resistance heater of the type that generates a predetermined power output when a resistive heating element made from a predetermined material has a predetermined mass and a predetermined resistance, the improvement comprising:
the resistive heating element comprising a plurality of sections made from the predetermined material and operable in combination to produce a total power output at least equal to the predetermined power output,
wherein the plurality of sections have a resultant resistance equal to the predetermined resistance,
wherein the plurality of sections are connected in parallel, and
wherein a total mass of the plurality of sections is less than the predetermined mass.
